(19) United States
(12) Patent Application Publication
(10) Pub. No.: US 2025/0083329 A1
(43) Pub. Date: Mar. 13, 2025

(54) DEVICE FOR HANDLING A MOTOR VEHICLE BODY COMPONENT

(71) Applicant: Dürr Systems AG, Bietigheim-Bissingen (DE)

(72) Inventor: Detlev Hannig, Winterbach (DE)

(21) Appl. No.: 18/576,209

(22) PCT Filed: Jul. 6, 2022
(86) PCT No.: PCT/EP2022/068677

§ 371 Date: Jan. 3, 2024

(30) Foreign Application Priority Data
Jul. 14, 2021 (DE) 10 2021 118 180.1

(51) Int. Cl. B25J 11/00; B05B 13/02; B05B 13/04; B25J 18/00; B25J 19/00

(52) U.S. Cl. CPC B25J 11/0075; B05B 13/0221; B25J 18/005; B25J 19/0058; B05B 13/0431

(57) ABSTRACT

The disclosure relates to a handling device that handles a motor vehicle body component, preferably for a coating operation of the motor vehicle body component and/or the motor vehicle body. The device includes an automatic movement machine and a gripping arm, that has a mounting means mounted to the automatic movement machine and at least one gripping tool for catching the motor vehicle body component, wherein the gripping arm includes, between the mounting means and the at least one gripping tool, a first deflection section, wherein the automatic movement machine is configured to bring the gripping arm into a working position. The handling device is characterized in particular in that the gripping arm comprises, between the first deflection section and the at least one gripping tool, a second deflection section. The disclosure also relates to a corresponding method and to a coating installation with such a handling device.

### CROSS-REFERENCE TO RELATED APPLICATIONS

This application is a national stage of, and claims priority to, Patent Cooperation Treaty Application No. PCT/EP2022/068677, filed on Jul. 6, 2022, which application claims priority to German Application No. DE 10 2021 118 180.1, filed on Jul. 14, 2021, which applications are hereby incorporated herein by reference in their entireties.

### FIELD

The disclosure relates to a handling device that handles (e.g. opening and/or closing) a motor vehicle body component of a motor vehicle body, in particular for a coating operation (e.g. painting operation) of the motor vehicle body component and/or the motor vehicle body. The motor vehicle body component can be, e. g., a door, hood or flap of the motor vehicle body. The disclosure also relates to a corresponding method and to a coating installation comprising such a handling device.

### BACKGROUND

From DE 10 2018105 041 A1 a handling device for handling, e. g., doors of motor vehicle bodies to be painted is known, in order to open the doors of the motor vehicle bodies to be painted as part of a painting operation, so that an interior of the motor vehicle bodies can also be painted. The handling device has a gripping arm with gripping tools, the gripping arm having two straight-lined gripping arm sections between which a deflection section is formed so that the two straight-lined gripping arm sections enclose an angle of 2° to 25° with their longitudinal axes. Because paint or paint overspray usually gets onto the gripping arm and the gripping tools during the painting operations, the gripping arm and the gripping tools must be cleaned at certain intervals. In addition, there is a risk that paint that has gotten onto the gripping arm and the gripping tools can drip off and thereby damage the doors and/or the motor vehicle bodies.

An object of the disclosure is to provide a handling device that has a cleaning cycle of a gripping arm with at least one gripping tool for catching a motor vehicle body component can be extended and/or where the gripping arm with the at least one gripping tool can be cleaned more efficiently. Alternatively or additionally, the handling device is intended in particular to reduce the risk of motor vehicle body components and/or motor vehicle bodies being damaged by dripping down coating agent (e.g. paint).

The object can be solved by the features of the independent claims. Advantageous developments of the disclosure are disclosed in the sub-claims or result from the following description of preferred embodiments of the disclosure.

### BRIEF DESCRIPTION OF THE DRAWINGS

FIG. 1 shows a handling device according to an embodiment of the disclosure,

FIG. 2 shows a gripping arm according to an embodiment of the disclosure, and

FIG. 3 shows the handling device of FIG. 1 in combination with a cleaning apparatus according to an embodiment of the disclosure.

### DETAILED DESCRIPTION

The disclosure relates to a handling device which handles (e.g. opening and/or closing) a motor vehicle body component of a motor vehicle body, in particular for a coating operation (e.g. painting operation) of the motor vehicle body component and/or the motor vehicle body.

In the coating operation, the motor vehicle body can preferably be coated, in particular its interior. However, it is alternatively or additionally also possible, e. g., that the motor vehicle body component is coated by the coating operation.

The motor vehicle body component is preferably part of the motor vehicle body.

The motor vehicle body component can be, e. g., a door, hood (e.g. engine hood or trunk hood) or flap of a motor vehicle body.

The handling device preferably includes an automatic movement machine (e.g., a swiveling unit and/or a handling robot (e.g., preferably having at least 3, 4, 5 or 6 degrees of freedom)) and a gripping arm.

The gripping arm includes a mounting means for mounting to the automatic movement machine and at least one gripping tool (e.g., at least one pin, at least one peg, at least one magnet, and/or at least one face with entrainment dowels) for catching the motor vehicle body component. The gripping arm comprises, between the mounting means and the at least one gripping tool, a first (e.g., kink-shaped or arc-shaped) deflection section.

The automatic movement machine is preferably configured to bring the gripping arm into a working position and, e. g., to handle the motor vehicle body component in the working position of the gripping arm (e.g., to open, to hold in its open position, and/or to close).

The automatic movement machine can be configured, e. g., to move the gripping arm expediently, e.g., into a working position, a basic position, and/or a cleaning position.

A special feature is that the gripping arm includes, between the first deflection section and the at least one gripping tool, a second (e.g., kink-shaped or arc-shaped) deflection section.

The second deflection section can preferably be configured to form, preferably in the working position of the gripping arm, a collection place for coating agent (e.g. paint) running down along the gripping arm and/or to allow coating agent (e.g. paint) to run off to the side of the mounting means and preferably thus in the direction away from the motor vehicle body component and/or away from the motor vehicle body. The coating agent can be coating agent, in particular, applied unintentionally to the at least one gripping tool and, possibly, to the gripping arm, e.g. paint mist and/or paint overspray (generated in particular by means of paint atomizers).

By means of the second deflection section, in particular, a collection place can thus be formed for coating agent running down along the gripping arm and/or coating agent (e.g. paint) can be expediently guided to the side of the mounting means.

The gripping arm is in its shaping, in particular, configured such that the coating agent can collect at the second deflection section, in particular at its lowest place (comparable to a “siphon effect”) and can preferably drip off outside the motor vehicle body component and/or the motor vehicle body (without interference and/or at an uncritical place).

The gripping arm with, in particular, the second deflection section enables, in particular, at least one of the following advantages:
Extension of cleaning intervals,
Cleaning (expediently automated in cleaning apparatus or manual cleaning) is facilitated and more efficient because cleaning can be carried out in a targeted manner at critical place,
Coating agent (e.g. paint) runs in a targeted manner to the lowest place of the second deflection section and can collect there (“siphon effect”),
Coating agent can drip off at a predefined place, namely expediently at the lowest place of the second deflection section,
Coating agent is, in a targeted manner, guided away from the motor vehicle body component and/or away from the motor vehicle body so that, e. g., in the event of drop formation the motor vehicle body component and/or the motor vehicle body is not contaminated, and/or
Reduction of the attack surface for coating agent during the coating operation.

It is possible that the second deflection section and/or the collection place forms a dripping place in order to collect and/or allow the coating agent to drip off at a predefined place, in particular the substantially lowest place of the second deflection section, preferably outside the motor vehicle body component and/or the motor vehicle body.

It is possible that the second deflection section, in particular in the working position of the gripping arm, is deformed downwards and/or creates a siphon effect, in particular for coating agent running down.

The first deflection section can preferably be deformed upwards, in particular in the working position of the gripping arm.

The second deflection section can preferably have an opening angle of, e. g., between 90° and 140°, between 100° and 130° or between 110° and 120°, wherein the opening angle can be defined, e. g., by two intersecting longitudinal axes of the second deflection section. Alternatively or additionally, the first deflection section can have an opening angle of, e. g., between 90° and 140°, between 100° and 130° or between 110° and 120°, wherein the opening angle can be defined, e. g., by two intersecting longitudinal axes of the first deflection section.

It is possible that a gripping arm section is formed between the second deflection section and the at least one gripping tool. The gripping arm section can, e.g., run substantially straight-lined, merge into the second deflection section on one side thereof and have the at least one gripping tool on the other side thereof and/or, in particular in the working position of the gripping arm, have with its longitudinal axis an angle relative to the horizontal of between +/−30, +/−25° or +/−20°.

It is possible that a gripping arm section is formed between the first deflection section and the second deflection section. The gripping arm section can, e. g., run substantially straight-lined, merge into the first deflection section on one side thereof and merge into the second deflection section on the other side thereof, and/or, in particular in the working position of the gripping arm, have with its longitudinal axis a downward angle towards the second deflection section of 25°+/−15°, +/−10° or +/−5° relative to the horizontal.

It is possible that a gripping arm section is formed between the mounting means and the first deflection section. The gripping arm section can, e. g., run substantially straight-lined, have the mounting means on one side thereof and merge into the first deflection section on the other side thereof, and/or, in particular in the working position of the gripping arm, have with its longitudinal axis an upward angle towards the first deflection section of 40°+/−15°, +/−10° or +/−5° relative to the horizontal.

The gripping arm is preferably formed from a round material (e.g. round hollow profile). Thus, at least one of the following parts may be formed of a round material: the first deflection section, the second deflection section, the gripping arm section formed between the mounting means and the first deflection section, the gripping arm section formed between the first deflection section and the second deflection section, and/or the gripping arm section formed between the second deflection section and the at least one gripping tool. However, the gripping arm is preferably formed of a round material along its substantially entire longitudinal extension between the mounting means and the gripping tool.

The first deflection section and/or the second deflection section can, e. g., be formed kink-shaped or arc-shaped.

The second deflection section can, e. g., comprise a substantially S-shape and/or comprise arcuate segments curved in different directions.

It is possible that at least two of the following parts extend in a common plane and, e.g. the common plane is preferably oriented perpendicular to the horizontal, in particular in the basic position, the working position and/or the cleaning position of the gripping arm: the first deflection section, the second deflection section, the gripping arm section formed between the mounting means and the first deflection section, the gripping arm section formed between the first deflection section and the second deflection section, and/or the gripping arm section formed between the second deflection section and the at least one gripping tool.

It is possible that the automatic movement machine comprises a handling robot (e.g. SCARA robot—SCARA: Selective Compliance Assembly Robot Arm) and a swiveling unit.

The swiveling unit is in particular mounted to the handling robot, wherein the mounting means can be expediently mounted to the swiveling unit. The swiveling unit is preferably configured to be able to swivel the gripping arm, in particular upwards and downwards.

In the context of the disclosure, the gripping arm can thus, e. g. be mounted to a swiveling unit. The swiveling unit can be mounted to a handling robot (e.g. SCARA robot).

The handling robot can additionally have, e. g., a perpendicular travelling axis in order to move the swiveling unit in a perpendicular direction. This can be useful, for example, if the gripping arm with the at least one gripping tool is to be inserted into a cleaning apparatus, e. g., from above to below. The swiveling unit with a travelling axis can optionally be integrated in a Scara robot or in a handling robot.

However, the swiveling unit is optional.

In the context of the disclosure, the automatic movement machine can be configured as a handling robot (e.g. with at least 3, 4, 5 or 6 degrees of freedom). The gripping arm can be mounted to the handling robot by means of the mounting means.

It is possible that a cleaning apparatus is provided and the gripping arm comprises a cleaning position, in which the at least one gripping tool and preferably the second deflection section is arranged within the cleaning apparatus in order to be cleaned by the cleaning apparatus in particular in an automated manner.

The automatic movement machine device can be configured, in particular, to bring the gripping arm into the cleaning position, in particular to insert the gripping tool and preferably the second deflection section into the cleaning apparatus.

In the cleaning position of the gripping arm, e. g., the gripping arm section formed between the first deflection section and the second deflection section can be oriented perpendicularly +/−10° or +/−5° to the horizontal.

The automatic movement machine can be configured, e. g., to bring the gripping arm into a working position, wherein, in the working position of the gripping arm, the at least one gripping tool engages with the motor vehicle body component (e.g. a window gap, a door gap, an inner side of a door or flap, an engagement structure (e.g. ring or hook) provided on the motor vehicle body component, etc.) and preferably in which the motor vehicle body component can be held (e.g. secured) in an open position by means of the gripping arm.

Alternatively or additionally, in the working position of the gripping arm, the motor vehicle body component and/or the motor vehicle body can preferably be coated, in particular by a coating robot, and/or the motor vehicle body component can be handled, in particular closed, by means of the gripping arm.

Advantageously, it is possible that the gripping arm is oriented in its working position, in particular during its movement sequence from opening to closing of the motor vehicle body component, always in such a way that, as previously discussed, coating agent can run off, be collected and/or drip off.

The automatic movement machine can also be configured, e. g., to bring the gripping arm into a basic position, e. g. between successive handling operations, in which the at least one gripping tool is not engaged with the motor vehicle body component.

In the basic position of the gripping arm, the at least one gripping tool is preferably not engaged with the motor vehicle body component. Nevertheless, the gripping arm can, e. g., also be oriented in the basic position in such a way that, by means of the second deflection section 14, coating agent can run off, can be collected and/or can drip off.

It is possible that a coating robot (e.g., painting robot) is provided and the coating robot is configured to coat the motor vehicle body component and/or the motor vehicle body. Here, the gripping arm can be in a working position in which the at least one gripping tool is engaged with the motor vehicle body component and in which, preferably, the motor vehicle body component is held (e.g. secured) in an open position by means of the gripping arm.

It is possible, e. g., that the gripping arm, in particular the second deflection section and/or the gripping arm section formed between the second deflection section and the at least one gripping tool, comprises a surface structuring (e.g. at least one groove, rib and/or drip off nose), in particular to ensure a predefined run off and/or dripping off of the coating agent.

The disclosure also comprises a coating installation (e.g., painting installation) for coating motor vehicle bodies and/or motor vehicle body components mounted thereto, comprising at least one handling device as disclosed herein.

The disclosure also comprises a method for handling a motor vehicle body component of a motor vehicle body, wherein the method can be carried out in particular by means of a handling device and/or a coating installation as disclosed herein.

In the context of the method, the motor vehicle body component can be brought into an open position by means of an automatic movement machine and a gripping arm, wherein the gripping arm comprises a mounting means, mounted to the automatic movement machine, and at least one gripping tool for catching the motor vehicle body component, and comprises a first deflection section between the mounting means and the at least one gripping tool. In the context of the method, the motor vehicle body component and/or the motor vehicle body can be coated with a coating agent (e.g. paint) by a coating robot (e.g. painting robot), while the at least one gripping tool, in particular in a working position of the gripping arm, is engaged with the motor vehicle body component and, e. g., the motor vehicle body component is held (e.g. secured) in the open position by means of the gripping arm.

A feature is that the gripping arm includes, between the first deflection section and the at least one gripping tool, a second (e.g. kink-shaped or arc-shaped) deflection section.

The second deflection section can be configured, as already explained, in order to form, in particular in the working position of the gripping arm, a collection place for coating agent (e.g. paint) running down along the gripping arm and/or in order to allow coating agent (e.g. paint) to run off to the side of the mounting means and thus preferably in the direction away from the motor vehicle body component and/or away from the motor vehicle body. The coating agent can in particular be coating agent applied unintentionally to the at least one gripping tool and, possibly, to the gripping arm, e.g. paint mist and/or paint overspray (generated in particular by means of paint atomizers).

It should be mentioned that the handling device is in particular configured to open the motor vehicle body component of the motor vehicle body so that an interior of the motor vehicle body can be coated. However, it is also possible, e. g., that the motor vehicle body component is coated by the coating robot.

It should be mentioned once again that in a working position of the gripping arm, preferably the at least one gripping tool can be in engagement with the motor vehicle body component, wherein the engagement can expediently take place, e. g., in a window gap, door gap, an inner side of a door or flap, an engagement structure (e.g. ring or hook) provided on the motor vehicle body component, etc. The engagement can thus take place, e. g., directly or indirectly.

It should also be mentioned that, preferably not only in the working position but also in the basic position of the gripping arm, the second deflection section can preferably be aligned to form a collection place for coating agent running down along the gripping arm, to allow coating agent to run off to the side of the mounting means and/or to form a dripping place for dripping off coating agent at a predefined place.

In particular, it is possible that at the first deflection section and/or the second deflection section, the longitudinal axis of the gripping arm has at least one (e. g. kink-shaped or arc-shaped) change of direction.

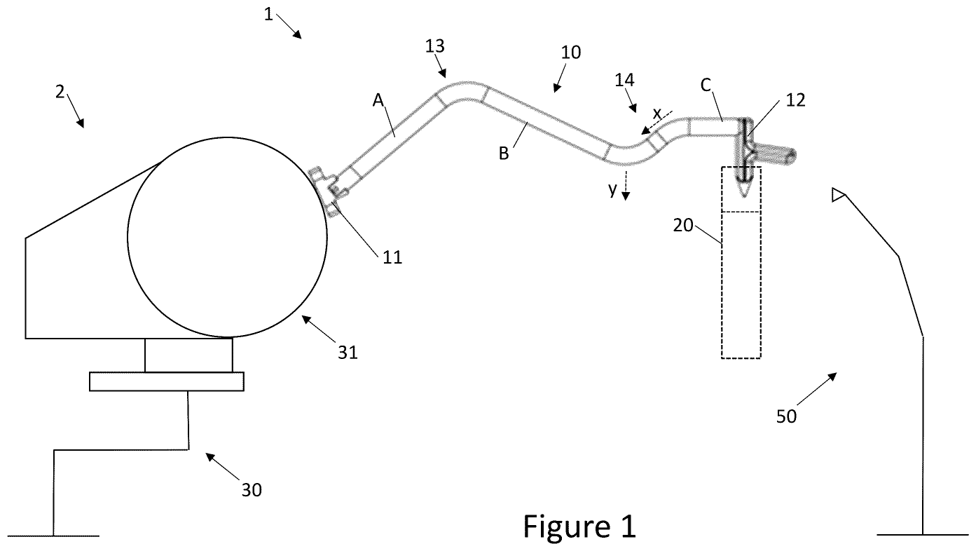

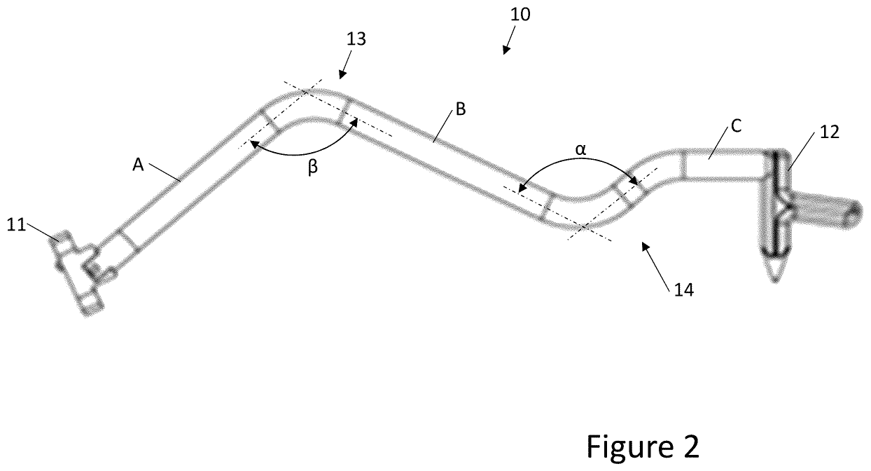

FIG. 1 shows a handling device 1 with a gripping arm 10 according to an embodiment of the disclosure, wherein FIG. 2 shows the gripping arm 10 in enlarged view.

The handling device 1 is used for handling, in particular for opening and/or closing, an only schematically shown motor vehicle body component 20 of a motor vehicle body. The motor vehicle body component 20 can be an openable and closable door, flap and/or hood of the motor vehicle body. Such motor vehicle body components 20 are usually to be brought into an open position so that, in particular, interiors of motor vehicle bodies can also be coated, e. g. with paint.

The handling device 1 comprises an automatic movement machine 2, which in the embodiment of FIG. 1 comprises a handling robot 30 (e.g. SCARA robot), which is only shown schematically, and a swiveling unit 31, which is mounted to the handling robot 30 and is also only shown schematically.

However, the swiveling unit 31 is optional.

In the context of the disclosure, the automatic movement machine 2 can be configured as a handling robot, e. g. with at least 3, 4, 5 or 6 degrees of freedom, so that a swiveling unit 31 is not required.

The automatic movement machine 2 can be configured, e. g., as disclosed in DE 10 2018 105 041 A1.

The gripping arm 10 is mounted, via a mounting means 11, to the automatic movement machine 2, in particular to the swiveling unit 31. In the event that no swiveling unit 31 is used, the mounting means 11 can be mounted to the handling robot.

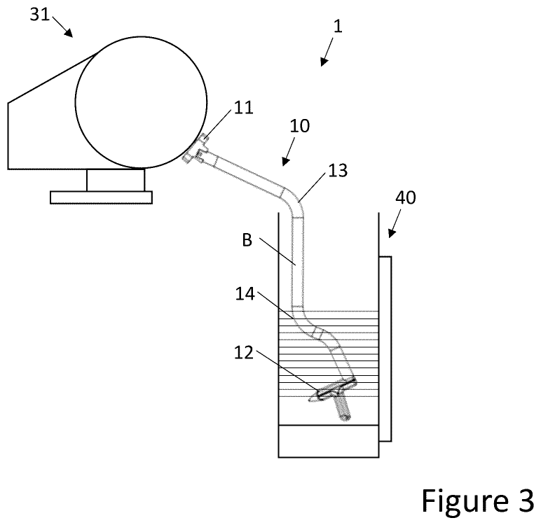

The automatic movement machine 2 is in particular configured to bring the gripping arm 10 into a working position and into a basic position and optionally into a cleaning position (e.g. FIG. 3).

The gripping arm 10 comprises at least one gripping tool 12 for catching the motor vehicle body component 20, e.g. a window gap, door gap, an inner side of a door or flap, an engagement structure (e.g. ring or hook) provided on the motor vehicle body component 20, etc.

The gripping arm 10 comprises, between the mounting means 11 and the gripping tool 12, a first preferably upwardly deformed arc-shaped deflection section 13.

The handling device 1 is usually used in combination with a coating robot 50, configured as a painting robot, shown only schematically, for coating the motor vehicle body component 20 and/or the motor vehicle body.

FIG. 1 shows the gripping arm 10 in a working position in which the gripping tool 12 is engaged with the motor vehicle body component 20 and in which the motor vehicle body component 20 is held (e.g. secured) in an open position by the gripping arm 10, while the motor vehicle body component 20 and/or the motor vehicle body is being coated by the coating robot 50.

During the coating operation, it is possible that the coating agent, e. g. in the form of paint mist or paint overspray, may unintentionally get onto the gripping tool 12 and the gripping arm 10.

Soiled gripping tools and soiled gripping arm sections basically involve the risk that the coating agent can drip off from them onto motor vehicle body components and/or motor vehicle bodies and thus damage the motor vehicle body components and/or motor vehicle bodies.

A special feature is that the gripping arm 10 comprises a second preferably downwardly deformed deflection section 14 between the first deflection section 13 and the gripping tool 12.

The second deflection section 14 is configured to form, in particular in the working position of the gripping arm 10 shown in FIG. 1, a collection place for coating agent running down along the gripping arm 10 and alternatively or additionally to allow the coating agent to run off to the side of the mounting means 11 and thus in the direction away from the motor vehicle body component 20 and away from the motor vehicle body, which is shown schematically by the arrow x in FIG. 1.

The collection place can preferably also form a dripping place in order to, at a predefined place, in particular at substantially the lowest place of the second deflection section 14, collect and allow the coating agent to drip off, preferably outside the motor vehicle body component 20 and in particular outside the motor vehicle body, which is shown schematically in FIG. 1 by the arrow y.

The gripping arm 10 can in its shaping consequently be configured in particular such that the coating agent can collect at the second deflection section 14, in particular at its lowest place (comparable to “siphon effect”) and can preferably drip off outside the motor vehicle body component 20 (expediently without interference and/or at an uncritical place).

The second deflection section 14 thus makes it possible, in particular, to guide coating agent that has reached the gripping tool 12 and the gripping arm 10 away from critical components (e.g. motor vehicle body component 20 and/or motor vehicle body), whereby advantageously the risk of damage to critical components can be reduced. In particular, the second deflection section 14 also makes it possible to focus coating agent that has reached the gripping tool 12 and the gripping arm 10, whereby advantageously the cleaning process can be carried out much more effectively, because the second deflection section 14 can be cleaned in a targeted manner in addition to the gripping tool 12 (e.g. manually or automatically in a cleaning apparatus (e.g. FIG. 3)).

The second deflection section 14 can, e. g., be formed kink-shaped or arc-shaped, be formed substantially U-shaped or V-shaped, comprise, e. g., a substantially S-shape, or have, e. g., two arcuate segments curved in different directions.

The second deflection section 14 can have an opening angle α of, e. g., between 90° and 140°, in particular of 115°+/−10°.

The first deflection section 13 can have an opening angle β of, e. g., between 90° and 140°, in particular of 115°+/−10°.

The gripping arm 10 includes, between the second deflection section 14 and the gripping tool 12, a gripping arm section C which runs substantially straight-lined, merges on one side thereof into the second deflection section 14 and has the gripping tool 12 on the other side thereof, and, in particular in the working position of the gripping arm 10, has with its longitudinal axis an angle relative to the horizontal of between +/−30, +/−25° or +/−20°.

The gripping arm 10 includes, between the first deflection section 13 and the second deflection section 14, a gripping arm section B which runs substantially straight-lined, merges on one side thereof into the first deflection section 13 and merges on the other side thereof into the second deflection section 14, and, in particular in the working position of the gripping arm 10, has with its longitudinal axis a downward angle towards the second deflection section 14 of 25°+/−15°, +/−10° or +/−5° relative to the horizontal.

The gripping arm 10 includes, between the mounting means 11 and the first deflection section 13, a gripping arm section A which runs substantially straight-lined, includes the mounting means 11 on one side thereof and merges into the first deflection section 13 on the other side thereof, and, in particular in the working position of the gripping arm 10, has with its longitudinal axis an upward angle towards the first deflection section 13 of 40°+/−15°, +/−10° or +/−5° relative to the horizontal.

Preferably, the second deflection section 14, the gripping arm section C and optionally the gripping arm section B can expediently be formed from a round material and have a round outer cross-section, in particular in order to promote a run off of the coating agent to its underside. However, the gripping arm 10 is preferably formed from a round material over substantially its entire longitudinal extent between the mounting means 11 and the gripping tool 12.

The second deflection section 14 and the gripping arm section C can, e. g., have a not shown surface structuring (e.g., at least one groove, rib and/or drip nose) in order to advantageously promote a predefined run off and/or dripping off of the coating agent.

The gripping arm 10 preferably extends between the mounting means 11 and the gripping tool 12 in only one plane, so that the first deflection section 13, the second deflection section 14, the gripping arm section A, the gripping arm section B and the gripping arm section C preferably extend in a common plane. However, embodiments are also possible in which the gripping arm 10 includes deformations not only upwards and downwards, but also to the side.

The automatic movement machine 2 is in particular configured to, in a working position of the gripping arm 10, in which the gripping tool 12 is in engagement with the motor vehicle body component 20, handle, in particular to open, hold in its open position and close the motor vehicle body component 20.

The automatic movement machine 2 thus serves in particular to bring the gripping arm 10 into a working position in which the gripping tool 12 is engaged with the motor vehicle body component 20 and in which the motor vehicle body component 20 is held in its open position by means of the gripping arm 10 while the motor vehicle body component 20 and/or the motor vehicle body is being coated. However, the automatic movement machine 2 also serves, of course, to open and close the motor vehicle body component 20 in the working position of the gripping arm 10, in which the gripping tool 12 is engaged with the motor vehicle body component 20.

Advantageously, it is possible that the gripping arm 10 is, in its working position, in particular during its preferably entire movement sequence from opening to closing the motor vehicle body component 20, always oriented such that, as previously discussed, coating agent can run off, can be collected and cab drip off.

In the basic position of the gripping arm 10, the gripping tool 12 is not engaged with the motor vehicle body component 20. Nevertheless, the gripping arm 10 can, e. g., also be oriented in the basic position such that coating agent can run off, can be collected and can drip off by means of the second deflection section 14.

FIG. 1 also illustrates a method for handling the motor vehicle body component 20 according to an embodiment of the disclosure, in the context of which the motor vehicle body component 20 is handled by means of the automatic movement machine 2 and the gripping arm 10, in particular is brought into an open position, and in the context of which the motor vehicle body component 20 and/or the motor vehicle body is coated with a coating agent by the coating robot 50, while the gripping tool 12 is engaged with the motor vehicle body component 20 and preferably the motor vehicle body component 20 is held in its open position by means of the gripping arm 10.

During the coating, the coating agent in the form of paint mist or paint overspray can unintentionally get onto the gripping tool 12 and parts of the gripping arm 10.

For this reason, as already mentioned, the gripping arm 10 includes the second deflection section 14, which is configured, in particular in the working position of the gripping arm 10 shown in FIG. 1, to advantageously form a collection place for coating agent running down along the gripping arm 10, to let the coating agent run off to the side of the mounting means 11 (x) and to let it drip off at a predefined, non-critical place (y).

The gripping arm 10 enables in particular at least one of the following advantages:
Extension of the cleaning intervals,
Cleaning (expediently in cleaning apparatus or manual cleaning) is facilitated and more efficient because cleaning can be carried out in a targeted manner at critical place,
Coating agent (e.g. paint) runs in a targeted manner to the lowest place of the second deflection section 14 and can collect there (“siphon effect”),
Coating agent can drip off at a predefined place, namely expediently at the lowest place of the second deflection section 14,
Coating agent is, in a targeted manner, guided away from the motor vehicle body component 20 and/or the motor vehicle body, so that, e. g., in the event of drop formation the motor vehicle body component 20 and/or the motor vehicle body is not contaminated, and/or
Reduction of the attack surface for coating agent during the coating operation, because in particular the gripping tool 12, the gripping arm section C and the second deflection section 14 can be positioned flat behind the motor vehicle body (e.g. flatter than in DE 10 2018 105 041 A1).

FIG. 3 shows the handling device 1 of FIG. 1 in combination with a cleaning apparatus 40 according to an embodiment of the disclosure, wherein the cleaning apparatus 40 and the cleaning operation can be carried out, e. g., as disclosed in DE 10 2018 105 041 A1.

However, an improved cleaning effect is possible because cleaning can be performed in a targeted manner at critical places of the gripping arm 10, in particular at the second deflection section 14.

FIG. 3 shows the gripping arm 10 in a cleaning position, in which the gripping tool 12 and preferably the second deflection section 14 are arranged within the cleaning apparatus 40 in order to be cleaned by the cleaning apparatus 40. Here, the gripping arm section B can in particular be oriented substantially perpendicular to the horizontal.

The cleaning in the cleaning apparatus 40 is performed by, in particular, applying, for example, rinsing agent and/or pulsed air to the gripping tool 12, the second deflection section 14 and the optional gripping arm section C.

The disclosure is not limited to the preferred embodiments described above. Rather, the disclosure also encompasses variations and modifications which also make use of the concept of the disclosure and therefore fall within the scope of protection. In particular, the disclosure also claims protection for the subject-matter and the features of the sub-claims independently of the respective claims referred to and in particular also without the features of the main claim. Thus, the disclosure includes different disclosure aspects which enjoy protection independently of each other.

1.-24. (canceled)

25. A handling device that handles a motor vehicle body component in a coating operation of the motor vehicle body component, comprising:
an automatic movement machine and
a gripping arm, the gripping arm including a mounting device mounted to the automatic movement machine and at least one gripping tool for catching the motor vehicle body component, wherein the gripping arm includes, between the mounting means and the at least one gripping tool, a first deflection section, wherein
the automatic movement machine is configured to bring the gripping arm into a working position, characterized in that the gripping arm includes, between the first deflection section and the at least one gripping tool, a second deflection section.

26. The device according to claim 25, wherein the second deflection section is configured to form, in the working position of the gripping arm, and further comprising a collection place for coating agent running down along the gripping arm.

27. The device according to claim 26, wherein the second deflection section is configured to allow, in the working position of the gripping arm, coating agent to run off to the side of the mounting device.

28. The device according to claim 25, wherein the second deflection section and the collection place form a dripping place in order to allow the coating agent to drip off at a predefined place.

29. The device according to claim 25 wherein when in the working position of the gripping arm, the second deflection section is deformed downwards and/or creates a siphon effect.

30. The device according to claim 29 wherein when in the working position of the gripping arm, the first deflection section is deformed upwards.

31. The device according to claim 25 wherein the second deflection section has an opening angle (α) of between 90° and 140°, between 100° and 130° or between 110° and 120°.

32. The device according to claim 25 wherein the first deflection section has an opening angle (β) of between 90° and 140°, between 100° and 130° or between 110° and 120°.

33. The device according to claim 25 wherein between the second deflection section and the at least one gripping tool, a gripping arm section is formed which
runs straight-lined,
merges on one side thereof into the second deflection section and has the at least one gripping tool on the other side thereof, and/or
in the working position of the gripping arm, has with its longitudinal axis an angle relative to the horizontal of between +/−30°, +/−25° or +/−20°.

34. The device according to claim 25 wherein between the first deflection section and the second deflection section, a gripping arm section is formed which
runs straight-lined,
merges on one side thereof into the first deflection section and merges on the other side thereof into the second deflection section, and/or
in the working position of the gripping arm, has with its longitudinal axis a downward angle towards the second deflection section of 25°+/−15°, +/−10° or +/−5° relative to the horizontal.

35. The device according to claim 25 wherein between the mounting means and the first deflection section, a gripping arm section is formed which
runs straight-lined,
has the mounting means on one side thereof and merges into the first deflection section on the other side thereof, and/or
I in the working position of the gripping arm, has with its longitudinal axis an upward angle towards the first deflection section of 40°+/−15°, +/−10° or +/−5° relative to the horizontal.

36. The device according to claim 25 wherein the gripping arm is formed from a round material.

37. The device according to claim 25 wherein at least two of the following parts extend in a common plane:
the first deflection section,
the second deflection section,
the gripping arm section formed between the mounting means and the first deflection section,
the gripping arm section formed between the first deflection section and the second deflection section,
the gripping arm section formed between the second deflection section and the at least one gripping tool.

38. The device according to claim 25 wherein the first deflection section and/or the second deflection section is formed kink-shaped or arc-shaped.

39. The device according to claim 25 wherein the second deflection section comprises an S-shape and/or two arcuate segments curved in different directions.

40. The device according to claim 25 wherein
the automatic movement machine comprises a handling robot and a swiveling unit, wherein the swiveling unit is mounted to the handling robot and the mounting device is mounted to the swiveling unit, or
the automatic movement machine is a handling robot.

41. The device according to claim 25 further comprising a cleaning apparatus and wherein the gripping arm comprises a cleaning position in which the at least one gripping tool and preferably the second deflection section is arranged inside the cleaning apparatus to be cleaned by the cleaning apparatus.

42. The device according to claim 41 wherein in the cleaning position of the gripping arm, the gripping arm section formed between the first deflection section and the second deflection section is oriented perpendicularly +/−10° or +/−5° to the horizontal.

43. The device according to claim 25 wherein the automatic movement machine is configured to bring the gripping arm into a working position in which the at least one gripping tool is engaged with the motor vehicle body component and preferably in which the motor vehicle body component is held in an open position by means of the gripping arm.

44. The device according to claim 25 wherein the automatic movement machine is configured to bring the gripping arm into a working position in which
the motor vehicle body component and/or the motor vehicle body is coated, and/or
the motor vehicle body component is handled by means of the gripping arm.
